(19) United States
(12) Patent Application Publication
(10) Pub. No.: US 2026/0082399 A1
(43) Pub. Date: Mar. 19, 2026

(54) SIDELINK PATH-SWITCH MANAGEMENT

(71) Applicant: Kyocera Corporation, Kyoto (JP)

(72) Inventors: Henry CHANG, San Diego, CA (US); Masato FUJISHIRO, Yokohama (JP)

(21) Appl. No.: 19/109,260

(22) PCT Filed: Sep. 13, 2023
(86) PCT No.: PCT/US2023/032597

§ 371 Date: Mar. 6, 2025

Related U.S. Application Data
(60) Provisional application No. 63/407,085, filed on Sep. 15, 2022.

(51) Int. Cl. H04W 72/25; H04W 40/24

(52) U.S. Cl. CPC H04W 72/25; H04W 40/246

(57) ABSTRACT

A user equipment (UE) device communicating with a peer UE device over an original sidelink communication path receives a sidelink path-switch criteria message from the peer UE device where the sidelink path-switch criteria message comprises sidelink path-switch criteria for establishing an alternate sidelink communication path between the UE device and the peer UE device. The alternate sidelink communication path may be a direct PCS link or a relay communication link through one or more alternate relay UE devices.

### CLAIM OF PRIORITY

The present application claims priority to Provisional Application No. 63/407,085, entitled “U2U Path Switch,” docket number TPRO 00378 US, filed Sep. 15, 2022, which is assigned to the assignee hereof and hereby expressly incorporated by reference in its entirety.

### FIELD

This invention generally relates to wireless communications and more particularly to sidelink path-switch management.

### BACKGROUND

Sidelink functionality allows a user equipment (UE) device to communicate directly with another UE device without utilizing a base station. Sidelink relaying functionality allows a remote user equipment (UE) device that is out-of-coverage (OoC) to connect with the gNB or base station via a relay UE device. Relay functionality allows one UE device to connect to another UE device over a relay communication link going through at least one relay UE. In some situations, the relay communication link may also go through one or more base stations or gNBs.

### SUMMARY

A user equipment (UE) device communicating with a peer UE device over an original sidelink communication path receives a sidelink path-switch criteria message from the peer UE device where the sidelink path-switch criteria message comprises sidelink path-switch criteria for establishing an alternate sidelink communication path between the UE device and the peer UE device. The alternate sidelink communication path may be a direct PC5 link or a relay communication link through one or more alternate relay UE devices.

### BRIEF DESCRIPTION OF THE DRAWINGS

FIG. 1A is a block diagram of an example of a system where a first UE device is communicating with a second UE device over an original sidelink communication path and the first UE device sends a sidelink path-switch criteria message.

FIG. 1B is a block diagram of an example of a direct sidelink communication path where the first UE device is connected to the second UE device over a direct PC5 connection.

FIG. 1C is a block diagram of an example of a single relay device relayed sidelink communication path where a single relay UE device facilitates communication between the first UE device and the second UE device.

FIG. 1D is a block diagram of an example of a multiple relay device relayed sidelink communication path where multiple relay UE devices facilitate communication between the first UE device and the second UE device.

FIG. 2 is a block diagram of an example of a base station (gNB) suitable for use as the gNB.

FIG. 3 is a block diagram of an example of a UE device suitable for use as each of the UE devices.

FIG. 4 is a block diagram of an example of a sidelink path-switch criteria message.

FIG. 5 is a block diagram the system for an example of a sidelink path-switch where the first UE device is communicating with a second UE device over the original sidelink communication path and the alternate sidelink communication path is a single relay device relayed communication path.

FIG. 6 is a message diagram of an example of a MBB sidelink path-switch between the first UE device and the second UE device where the alternate sidelink communication path is single relay UE device relayed communication path.

FIG. 7 is a message diagram of an example of a MAB sidelink path-switch between the first UE device and the second UE device where the alternate sidelink communication path is single relay UE device relayed communication path.

FIG. 8 is a flow chart of an example of a method of performing an MBB path-switch procedure.

FIG. 9 is a flow chart of an example of a method of performing an MAB path-switch procedure.

### DETAILED DESCRIPTION

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D).

In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying, and the relay UE device establishes a communication path between the remote UE and a base station (gNB) or cell. In some situations, for example, the UE device may be out of the service area of the base station, and the relay UE device provides a communication link routed from such an out-of-coverage (OoC) UE device through the relay UE device to the base station. Where the destination device is another UE device (target UE device, peer UE device, destination UE device, etc.), the relaying functionality is typically referred to as UE-to-UE (U2U) relaying.

Thus, sidelink relaying functionality allows a remote UE that is out-of-coverage (OoC) to connect with the gNB or base station via a relay UE device. With UE-to-Network (U2N) relaying, the relay UE needs to be in coverage of a cell and connected to the gNB. The relayed connection from the remote UE device to the base station (gNB) includes (1) at least one PC5 link (sidelink) between the remote UE device and the relay UE device, and optionally (2) a direct communication link (e.g., Uu link) between the relay UE device and the gNB.

Since the UE devices are not necessarily stationary, it is possible that the relative positions between the UE devices changes and that one or more links may deteriorate. Where a first UE device is communicating through a relay UE device with a second UE device, the first hop PC5 link between the first UE device and the relay device and/or the second hop PC5 link between the relay UE device and the second UE device may deteriorate, experience a radio link failure (RLF), or otherwise fall below an acceptable quality threshold to continue communication over the relay link. Similarly, the direct sidelink between two UE devices may fall below an acceptable quality threshold or become disabled. With conventional systems, a new communication link must be established in these situations after the original connection fails. In other words, conventional systems do not allow for managing a path switch to a new path. As a result, conventional systems suffer from inefficient and time-consuming techniques for continuing data communication between two UE devices communicating over a sidelink communication path that can longer be maintained.

In accordance with the examples discussed herein, however, UE devices communicating over an original sidelink communication path exchange sidelink path-switch criteria for establishing an alternative sidelink communication path between the UE device and the peer UE device. The sidelink path-switch criteria may apply to a make-before-break (MBB) path switch or a maker-after-break (MAB) path switch and includes information for selecting and executing a path switch to the alternate sidelink communication path. Such information may include link quality thresholds, triggers, timers, parameters related to a number of acceptable relay UE devices forming the alternate sidelink communication path, preferred relay UE devices, and a designation of the path-selecting UE device. The original sidelink communication path and the alternate sidelink communication path may be a relayed communication path with one or more relay UE devices or a direct sidelink connection between the UE device and the peer UE device

Although the techniques discussed herein may be applied to various types of systems and communication specifications, the devices of the example operate in accordance with at least one revision of the 3^{rd} Generation Partnership Project (3GPP) New Radio (NR) V2X communication specification. The techniques discussed herein, therefore, may be adopted by one or more future revisions of communication specifications, although the techniques may be applied to other communication specifications where sidelink or D2D and relay functionality are employed. More specifically, the techniques may be applied to current and future releases of 3GPP NR specifications. For example, the techniques may also be applied to 3GPP NR (3GPP Rel-17) and 3GPP Rel-18.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

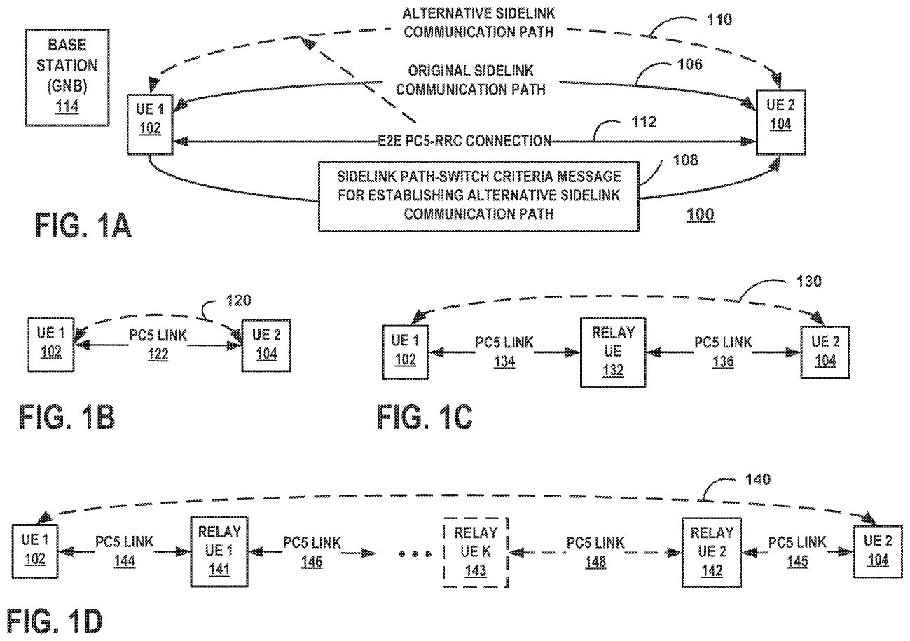

FIG. 1A is a block diagram of an example of a system 100 where a first UE device 102 is communicating with a second UE device 104 over an original sidelink communication path 106 and the first UE device 102 sends a sidelink path-switch criteria message 108. The original sidelink communication path 106 may be a direct sidelink connection (PC5 connection) between the two devices 102, 104 or may be a relayed sidelink connection where one or more relay UE devices facilitates data communication between the two devices. The sidelink path-switch criteria message 108 includes criteria and/or other information for establishing an alternate sidelink communication path 110 between the two UE devices 102, 104. The criteria are discussed below in further detail and provide at least one parameter that is used by at least one of the UE devices 102, 104 to establish the alternate sidelink communication path 108. For the examples, an end-to-end (E2E) PC5 Radio Resource Control (RRC) connection 112 used for communicating over the original sidelink communication path is used for the alternate sidelink communication path 110 after the sidelink(s) facilitating the alternate sidelink communication path 110 are established. Accordingly, the sidelink path-switch criteria message 108 facilitates a sidelink path-switch from the original sidelink communication path 106 to the alternate sidelink communication path 110. The path-switch may be from a direct PC5 connection to a relayed sidelink connection, from a relayed sidelink connection to a direct PC5 connection, or from one relayed sidelink connection to another relayed sidelink connection that uses at least one relay UE device different from the original relayed sidelink connection. In some circumstances, a relay sidelink connection may include more than one relay UE device. Although the sidelink path switch criteria message may be transmitted in different ways, an example of suitable technique for transmitting the sidelink path-switch criteria message includes transmitting an RRC Reconfiguration Sidelink message. In another example, the sidelink path-switch criteria message the is a PC5-RRC message.

In some examples, the path-switch is a make-before-break (MBB) path-switch where the alternate sidelink communication path 110 is established while the original sidelink communication path 106 supports communication between the first UE device 102 and the second UE device 104. For the MBB path-switch, therefore, the alternate sidelink communication path 110 is established before the original sidelink communication path 106 is disconnected or otherwise becomes inoperable and no longer supports communication between the first UE device 102 and the second UE device 104. Some examples of triggers for initiating a MBB path-switch include one of the UE devices 102, 104 detecting a link quality below a threshold for a sidelink in the path 106 and a change a quality of service (QOS) requirement for the communication between the UE devices 102, 104. Link quality may be determined based on sidelink (SL) reference signal received power (RSRP) measurements and thresholds. For the example, the link quality threshold is part of the sidelink path-switch criteria negotiated by the UE devices. In other situations, the path-switch trigger is provided by a base station.

In other examples, the path-switch is a make-after-break (MAB) path switch where the alternate sidelink communication path 110 is established after the original sidelink communication path 106 no longer supports communication between the first UE device 102 and the second UE device 104. For example, the information provided in the sidelink path-switch criteria message 108 facilitates the establishment of the alternate sidelink communication path 110 after the original sidelink communication path 106 experiences a sidelink radio link failure (SL RLF) in at least one sidelink connection of the original sidelink communication path 106. An example of a trigger for initiating a MAB path-switch includes one of the UE devices 102, 104 detecting a SL RLF.

For both an MBB path-switch and an MAB path switch, the sidelink path-switch criteria message 108 is transmitted over the original sidelink communication path 106. In some situations, however, additional information for establishing the alternate sidelink communication path 110 may be exchanged between the UE devices 102, 104 over the original sidelink communication path 106 during an MBB path-switch procedure.

The system 100 also includes a base station (gNB) 114 for the example. In many situations, the base station 114 is not directly involved in the sidelink path-switch procedure. The base station 114, however, may facilitate configuration parameters of the UE devices 102, 104, and relay UE devices or provide other system operational parameters. In some situations, for example, the base station 120 may allocate and manage communication resources where one or more of the UE devices 102, 104, or relay UE devices are in coverage (InC) of the base station 114. In some situations, the base station 114 may configure the devices 102, 104 with thresholds for triggering a path-switch.

After the PC5 connection(s) for the alternate sidelink communication path 110 are established, the E2E PC5 RRC connection 112 is applied to the alternate sidelink communication path 110. The UE context for each peer device for the E2E PC5 RRC connection 112 is retained and applied to the alternate sidelink communication path 110. A second UE device UE context is maintained at the first UE device 102 where the UE context includes at least the Packet Data Convergence Protocol (PDCP) configuration and Service Data Adaptation Protocol (SDAP) configuration for the E2E PC5 RRC connection 112 and the second device UE capability. A first UE device UE context is maintained at the second UE device 104 where the UE context includes at least the PDCP configuration and Service Data Adaptation Protocol (SDAP) configuration for the E2E PC5 RRC connection 112 and the first device UE capability. As is known, the SDAP sublayer is positioned above the PDCP layer and is configured by E2E PC5-RRC. The SDAP sublayer maps QoS flows to Sidelink Data Radio Bearers (SL-DRBs) where one or more QoS flows may be mapped onto one DRB. For the path-switch examples described herein, the PDCP is not re-established as would typically be needed during a new link establishment. Furthermore, the PDCP SN (Sequence Number) is kept between the first UE device and the second UE device.

FIG. 1B is a block diagram of an example of a direct sidelink communication path 120 where the first UE device 102 is connected to the second UE device 104 over a direct PC5 connection 122. With a direct sidelink communication path 120, the two UE devices communicate directly with each other without a relay UE device over PC5 connection. As discussed with reference to the examples herein, the original sidelink communication path 106 or the alternate sidelink communication path 110 may be a direct sidelink communication path 120 in some situations.

FIG. 1C is a block diagram of an example of a single relay device relayed sidelink communication path 130 where a single relay UE device 132 facilitates communication between the first UE device 102 and the second UE device 104. The relay UE device 132 communicates with the first UE device 102 over a first hop PC5 connection 134 and communication with the second UE device 104 over a second hop PC5 connection 136. The terms “first” and “second” are for labeling purposes and do not suggest any order in operation, timing, or importance for the two connections 134, 136. As discussed with reference to the examples herein, the original sidelink communication path 106 and/or the alternate sidelink communication path 110 may be a single relay device relayed sidelink communication path 130 in some situations.

FIG. 1D is a block diagram of an example of a multiple relay device relayed sidelink communication path 140 where multiple relay UE devices 141-143 facilitate communication between the first UE device 102 and the second UE device 104. The multiple relay device relayed sidelink communication path 140, includes at least a first relay UE device 141 and a second relay UE device 142. The multiple relay device relayed sidelink communication path 140, however, may include any number of additional relay UE devices 143. One relay UE device 141 is connected to the first UE device 102 via a first hop PC5 connection 144 and another relay UE device 142 is connected through a last PC5 connection 145 to the second UE device 104. Where the multiple relay device relayed sidelink communication path 140 includes two relay UE devices 102, 104, the two relay UE devices are connected through a middle hop PC5 connection 146. Each additional relay UE device in the path 140 is connected to adjacent relay UE devices through additional middle hop PC5 connections 148 such that a serial string of PC5 connected relay UE devices 141-143 is formed. The terms “first”, “middle” and “last” are for labeling purposes and do not suggest any order in operation, timing, or importance for the PC5 connections 144-148. As discussed with reference to the examples herein, the original sidelink communication path 106 and/or the alternate sidelink communication path 110 may be a multiple relay device relayed sidelink communication path 140 in some situations.

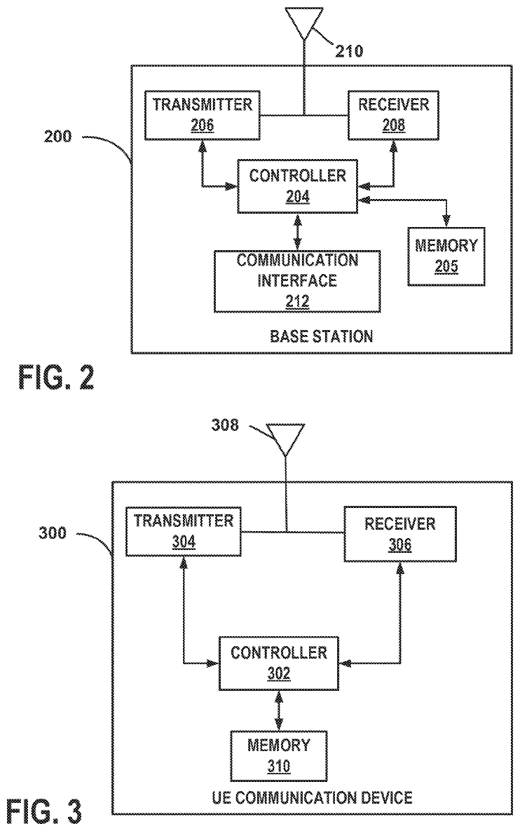

FIG. 2 is a block diagram of an example of a base station (gNB) 200 suitable for use as the base station (gNB) 114. The base station 200 includes a controller 204, transmitter 206, and receiver 208, as well as other electronics, hardware, and code. The base station 200 is any fixed, mobile, or portable equipment that performs the functions described herein. The various functions and operations of the blocks described with reference to the base station 106 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory 205. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. The antenna 210 may also include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 102, 104, 132, 141, 142, 143, 506, 508. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory 310. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device. At least the transmitter 304 and receiver 306 form a transceiver in the example. The controller 308 and memory 310 may also be part of the transceiver.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

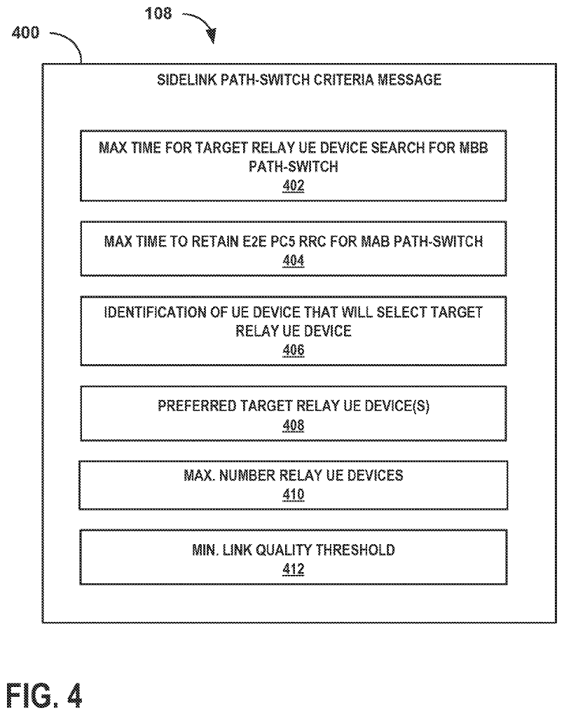

FIG. 4 is a block diagram of an example of a sidelink path-switch criteria message 400. The sidelink path-switch criteria message 400 may include additional parameters, criteria, and information and is one example of a message suitable for use as the sidelink path-switch criteria message 108. The sidelink path-switch criteria message 400 may include criteria for make-before-break (MBB) path-switch procedures, criteria for make-after-break (MAB) path-switch procedures, or for both MBB and MAB path-switch procedures. Some of the criteria in the sidelink path-switch criteria message 400 may apply to all path-switch procedures while other criteria may only apply to only one type of path-switch procedure.

The sidelink path-switch criteria message 400 includes at least time limit criteria limiting the maximum time the second UE device 104 searches for an alternate sidelink communication path 110. For the example, an MBB maximum search time parameter 402 indicates the maximum time the second UE device 104 should search during an MBB path-switch for a suitable target relay UE device for providing the alternate sidelink communication path 110. The MBB maximum search time parameter 402, therefore, indicates when the second UE device should stop the MBB path-switch procedure after it is initiated. In some situations, the MBB path-switch procedure is initiated at the second UE device in response to the receipt of the sidelink path-switch criteria message 400. Accordingly, the second UE device may start a timer in response to receiving the sidelink path-switch criteria message 400. In other situations, a separate message may trigger the MBB path-switch procedure and start the timer. In still other situations, the MBB path-switch procedure is triggered by the second UE device detecting the trigger condition (e.g., link quality falling below a threshold). When the maximum time has been reached and no suitable target relay UE has been identified the second UE device 104 stops the search. The second UE device 104 may transmit its own sidelink path-switch criteria message 400 to the first UE device 102 or may wait to receive another message from the first UE device 102 while continuing communication over the original sidelink communication path 106.

For the example of FIG. 4, the sidelink path-switch criteria message 400 includes an MAB maximum search time parameter 404 that indicates the maximum time the second UE device 104 should retain the E2E PC5 RRC connection during an MAB path-switch search for a suitable target relay UE device for providing the alternate sidelink communication path 110. The MAB maximum search time parameter 404, therefore, indicates when the second UE device should stop the MAB path-switch procedure after it is initiated. Typically, the MAB path-switch procedure is initiated at the second UE device 104 in response to the second UE device determining that the original sidelink communication path no longer supports communication. The second UE device 104, for example, may initiate the MAB path-switch and start a timer in response to detecting an SL RLF. If no alternate sidelink communication path is identified when the timer expires, the second UE device 104 discards the E2E PC5 RRC connection and attempts to establish a new communication session with the first UE device 102 in accordance with conventional techniques.

A designated relay device selector identification 406 indicates which of the two UE devices 102, 104 will select the relay UE device for the alternate sidelink communication path 110. Although the designated relay device selector identification 406 may be used for both MAB path-switch procedures and MBB path-switch procedures, the identifying parameter 406 provides advantages for MAB path-switch procedures. Where the original sidelink communication path 106 experiences a sidelink RLF, for example, both UE devices 102, 104 may search for a target relay UE device and select different relay UE devices which requires further messaging and processing to resolve the mismatch. Such a situation may add latency and inefficiency to the MAB path-switch procedure. By designating one the UE devices with the designated relay device selector identification 406, however, a single target relay UE device is selected by the designated relay-selecting UE device.

The sidelink path-switch criteria message 400 includes a preferred target relay UE device list 408 that identifies at least one preferred target relay. Before sending the sidelink path-switch criteria message 400, the first UE device 102 may evaluate circumstances to identify one or more target relay UE devices that are suitable for providing an alternate sidelink communication path 110. The preferred target relay UE device list 408 may be used for MBB path-switch procedures and/or for MAB path-switch procedures.

A maximum number of relay UE devices parameter 410 is a threshold indicating the maximum number of relay UE devices that can be included in the alternate sidelink communication path 110. In some cases, the parameter 410 does not indicate a maximum number or indicates that there is no limit to the number of relay UE devices that can be used to establish the alternate sidelink communication path 110. In other situations, the parameter 410 is zero or otherwise indicates that the alternate sidelink communication path 110 should be a direct PC5 connection between the two UE devices 102, 104. In most situations, however, the parameter 410 indicates an integer greater than or equal to one. The second UE device 104, therefore, only selects an alternate sidelink communication path 110 that includes a number of relay UE devices less than or equal to the number indicated by the maximum number of relay UE devices parameter 410. The maximum number of relay UE devices parameter 410 may be used for MBB path-switch procedures and/or for MAB path-switch procedures.

For the example, the sidelink path-switch criteria message 400 includes a minimum link quality threshold 412. The minimum link quality threshold 412 indicates the minimum quality of at least one communication link in the alternate sidelink communication path. In many situations, the second UE device 104 will only have information related to the direct link to a candidate target relay UE device and related to the direct sidelink to the first UE device. Accordingly, the second UE device 104 only selects alternate sidelink communication paths where the direct link to the relay UE device (or the direct link to the first UE device) has a quality level greater than or equal to the minimum link quality threshold 412. In some situations, the second UE device 104 may have information related to the other links in the candidate alternate sidelink communication path and only considers an alternate sidelink communication path where all links with available quality information within the path meet the quality threshold 412. If the candidate alternate sidelink communication path is a single relay device path and the candidate relay UE device indicates the quality of the link from the candidate relay UE device to the first UE device 102, for example, the second UE device 104 selects the candidate relay UE device only if both the link to the relay UE device and the link between the relay UE device and the first UE device 104 meet the minimum link quality threshold 412. Example of suitable minimum link quality thresholds 412 include an SL RSRP threshold and a sidelink discovery (SD) RSRP.

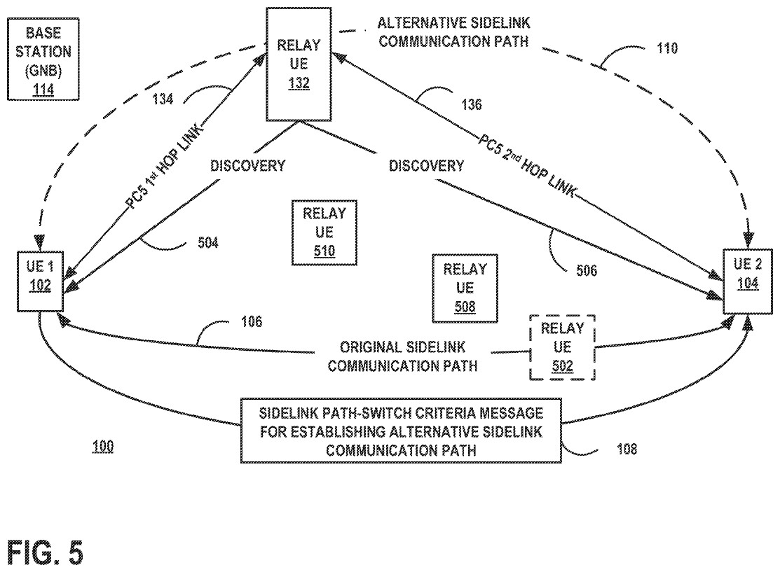

FIG. 5 is a block diagram the system 100 for an example of a sidelink path-switch where the first UE device 102 is communicating with a second UE device 104 over the original sidelink communication path 106 and the alternate sidelink communication path 110 is a single relay device relayed communication path 130. The original sidelink communication path 106 may be a direct sidelink communication path 120, a single relay device relayed communication path 130, or may be a multiple relay device relayed communication path 140. Where the original sidelink communication path 106 is a relayed communication path with the same number of relay UE devices as the alternate sidelink communication path 110, the alternate sidelink communication path 110 includes at least one relay UE device that is different from the original sidelink communication path 106. For the example of FIG. 5, therefore, the relay UE device facilitating the original sidelink communication path 106 is different from the relay UE device 132 in the alternate sidelink communication path 110.

While connected to the second UE device 104 via the original sidelink communication path 106, the first UE device 102 sends a sidelink path-switch criteria message 108 for establishing an alternate sidelink communication path. The sidelink path-switch criteria message 108 may include any combination of parameters, preferences, instructions, thresholds or other information related to establishing an alternate sidelink communication path 110. In some examples, the sidelink path-switch criteria message 108 is the sidelink path-switch criteria message 400 discussed with reference to FIG. 4.

The relay UE device 132 transmits discovery signals 502, 504 that are received by the first UE device 102 and the second UE device 104. In some situations, the discovery signals 502, 506 may be the same discovery signal. Where the discovery signals 502, 506 are a Model A discovery signals, for example, the same broadcasted discovery signal may be received by both UE devices 102, 104. In other situations, the discovery signals are different signals. Where both signals are Model B discovery signals transmitted in response to a Model B request from each UE device 102, 104, for example, the signals 504, 506 are different. The second UE device 104 may also receive discovery signals (not shown) from other candidate relay UE devices 508, 510. The second UE device 104 evaluates the received discovery signals from the candidate relay UE device 132, 508, 510 and applies the criteria in the sidelink path-switch criteria message 108 to select the alternate sidelink communication path 110. The second UE device 104 compares the measured SD RSRP levels of the received discovery signals from the candidate relay UE device 132, 508, 510 and determines that the relay UE device 132 meets the quality threshold, for example. In another example, the alternate sidelink communication path 110 may be selected over another sidelink communication path including two relay UE devices 508, 510 because the maximum relay device number indicated by the sidelink path-switch criteria message 108 is limited to one relay UE device.

Where the sidelink path-switch is a MBB path-switch, the alternate sidelink communication path is established while the original sidelink communication path 106 still supports communication between the two UE devices 102, 104. Where the sidelink path-switch is an MAB path-switch, the alternate sidelink communication path is established after the original sidelink communication path 106 has ceased to support communication between the two UE devices 102, 104.

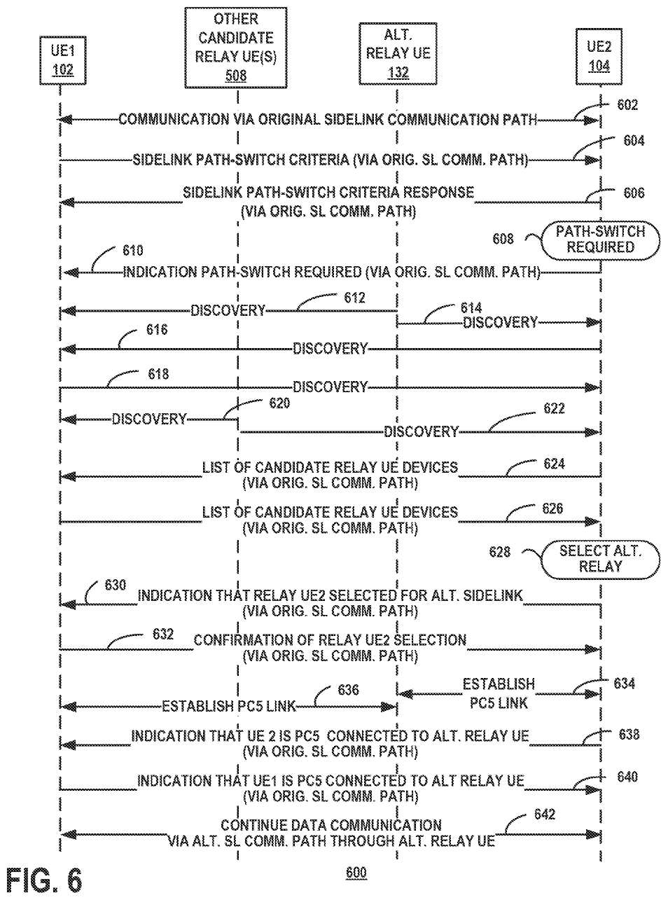

FIG. 6 is a message diagram of an example of a MBB sidelink path-switch between the first UE device 102 and the second UE device 104 where the alternate sidelink communication path 110 is single relay UE device relayed communication path. The message exchange and events discussed with reference to FIG. 6, therefore, are an example of the technique discussed with reference to FIG. 5 for a MBB path-switch scenario.

At event 602, data is exchanged in a communication session between the first UE device 102 and the second UE device 104. The example of FIG. 6 begins with the first device UE device 102 communicating with the second UE device over sidelink communication connection that may be a U2U relay link facilitated by one or more relay UE devices or may be a direct PC5 connection between the UE devices 102, 104.

A transmission 604, the first UE device 102 transmits a sidelink path-switch criteria message to the second UE device 104 over the original sidelink communication path. For the example of FIG. 6, the sidelink path-switch criteria at least includes a minimum link quality threshold and maximum time limit for searching for the alternate sidelink communication. For the examples herein, a timer for the maximum time limit is started when the path-switch procedure is initiated and is stopped when the alternate sidelink communication path is identified. The criteria may include additional parameters and thresholds as discussed above. With the minimum link quality threshold, the criteria provide the conditions and trigger for initiating a path-switch. For the example, the minimum link quality threshold is a minimum SL RSRP. An example of suitable technique for transmitting the sidelink path-switch criteria message includes transmitting an RRC Reconfiguration Sidelink message. In another example, the sidelink path-switch criteria message is a PC5-RRC message.

At transmission 606, the second UE device 104 transmits a sidelink path-switch criteria response message to the first UE device 102 over the original sidelink communication path. In some situations, the sidelink path-switch criteria response may be an acknowledgement confirming the sidelink path-switch criteria. In other situations, the sidelink path-switch criteria response indicates a requested change to the criteria such as an adjusted threshold, for example. Accordingly, the first UE device and the second UE device may negotiate to settle on a final agreed sidelink path-switch criteria. Additional sidelink path-switch criteria responses and messages may be exchanged between the devices 102, 104. In still other situations, the sidelink path-switch criteria response may be omitted.

At event 608, the second UE device 104 determines that a path-switch is required. For the example, the second UE device 104 compares a measured SL RSRP to the SL RSRP threshold to determine whether a path-switch is required. For example, the second UE device measures the SL RSRP of a signal transmitted from a relay UE device when the original sidelink communication path is a relayed communication path and measures the SL RSRP of a signal transmitted by the first UE device when the original sidelink communication path is a direct PC5 connection between the UE devices 102, 104.

At transmission 610, the second UE device transmits an indication that a path-switch is required. The indication is transmitted over the original sidelink communication path. The indication, therefore, is transmitted in response to the UE device 104 determined that the measured SL RSRP is below the minimum threshold. In some situations, the first UE device may also determine that a path-switch is required and may also initiate a path-switch procedure.

At transmission 612, a discovery signal is transmitted by an alternate relay UE device 132 and received by the first UE device 102. At transmission 614, a discovery signal is transmitted by the alternate relay UE device 132 and received by the second UE device 104. At transmission 616, a discovery signal is transmitted by second UE device 104 and received by the first UE device 102. At transmission 618, a discovery signal is transmitted by the first UE device 102 and received by the second UE device 104. At transmission 620, a discovery signal is transmitted by another candidate relay UE device 508 and received by the first UE device 102. At transmission 620, a discovery signal is transmitted by another candidate relay UE device 508 and received by the second UE device 104. Other discovery signals may be transmitted by other candidate relay UE device and received by the UE devices 102, 104. The transmissions 612, 612, 616, 618, 610, 622 may be Model A discovery signals or Model B discovery signals. In situations, where the discovery signals are Model B discovery signals, discovery signal requests (discovery queries) are received at the transmitting device to invoke the transmission of the Model B discovery signal. In the interest clarity and brevity, the discovery request transmissions are not shown in FIG. 6.

The second UE device evaluates the received discovery signals and generates a candidate relay UE device list that includes at least one candidate relay UE device. The second UE device 104 evaluates at least the SD RSRP of the discovery signals to generate the candidate relay UE device list. In some situations, other information may be available to the second UE device to generate the candidate list. Examples of such information include, neighbor devices of the devices transmitting discovery signals and link quality information to those neighbor devices. Accordingly, the candidate list may include relay UE devices that can provide multiple rely UE device communication paths. Only relay devices providing the alternate sidelink communication paths meeting the criteria are included in the candidate relay UE device list. Where the sidelink path-switch criteria includes a maximum relay device threshold, for example, only UE devices capable of providing an alternate communication path with a number of relay devices less than the threshold are included in the candidate relay UE device list. At transmission 624, the second UE device sends a message to the first UE device indicating the list of candidate relay UE devices. At transmission 626, the first UE device sends a message to the second UE device indicating the list of candidate relay UE devices identified by the first UE device. In some situations, a UE device may determine that a sidelink direct connection to the other UE device meets the criteria for the alternate sidelink communication path and may indicate the option in the list of candidate relay UE device transmission to the other UE device.

At event 628, the second UE device 104 selects a relay UE device for providing the alternate sidelink communication path. In some situations, the second UE device 104 may select a direct sidelink connection between the two devices 102, 104. The second UE device at least evaluates the list of candidate relay UE devices received from the first UE device to select a relay UE device. The UE device 104 may compare its own list to the list from the first UE device to select a relay UE device. The second UE device may also consider other information in selecting the relay UE device where examples of such information include link quality information, number of relay devices for the alternate sidelink communication path, and the communication capabilities of the relay UE device (e.g., minimum QoS level). Although for the example of FIG. 6 the second UE device selects the alternate sidelink communication path, the first UE device may select the alternate sidelink communication path in some situations. For the example, the sidelink path-switch criteria include a designation of the second UE device as the path selecting device.

At transmission 630, the second UE device sends a message to the first UE device indicating the selected relay UE device. For the example, the second UE device selects the alternate relay UE device 132 and indicates the selection to the first UE device. At transmission 632, the first UE device sends a message confirming the selection of the alternate relay UE device 132.

At event/transmission 634, the second UE device establishes a PC5 connection with the alternate relay UE device 132. At event/transmission 636, the first UE device establishes a PC5 connection with the alternate relay UE device 132. For the example, the PC5 connections are established using conventional techniques.

At transmission 638, the second UE device sends a message to the first UE device indicating that the second UE device is connected to the alternate relay UE device 132 using the existing E2E PC5-RRC connection. At transmission 640, the first UE device sends a message to the second UE device indicating that the first UE device is connected to the alternate relay UE device 132. The transmissions 638, 640 are over the original sidelink communication path.

At event/transmission 642, communication between the first UE device and the second UE device continues over the alternate sidelink communication path provided by the alternate relay UE device 132.

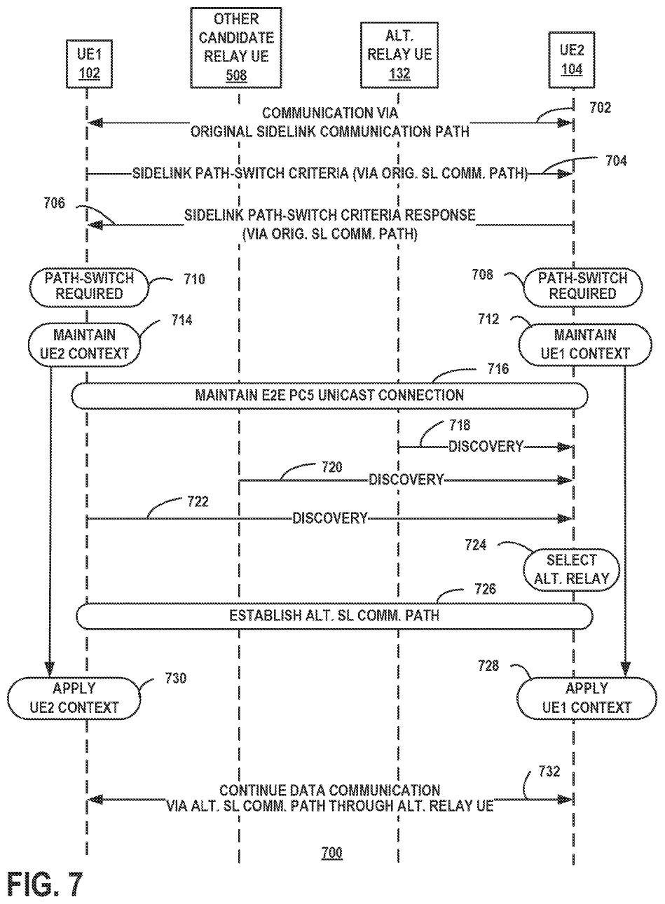

FIG. 7 is a message diagram of an example of a MAB sidelink path-switch between the first UE device 102 and the second UE device 104 where the alternate sidelink communication path 110 is single relay UE device relayed communication path. The message exchange and events discussed with reference to FIG. 7, therefore, are an example of the technique discussed with reference to FIG. 5 for a MAB path-switch scenario.

At event 702, data is exchanged in a communication session between the first UE device 102 and the second UE device 104. The example of FIG. 7 begins with the first device UE device 102 communicating with the second UE device over sidelink communication connection that may be a U2U relay link facilitated by one or more relay UE devices or may be a direct PC5 connection between the UE devices 102, 104.

A transmission 704, the first UE device 102 transmits a sidelink path-switch criteria message to the second UE device 104 over the original sidelink communication path. For the example of FIG. 7, the sidelink path-switch criteria at least includes a minimum link quality threshold, maximum time limit for retaining the E2E PC5 RRC, identification of the UE device that will select target relay UE device. The criteria may include additional parameters and thresholds as discussed above. An example of suitable technique for transmitting the sidelink path-switch criteria message includes transmitting an RRC Reconfiguration Sidelink message. In another example, the sidelink path-switch criteria message is a PC5-RRC message.

At transmission 706, the second UE device 104 transmits a sidelink path-switch criteria response message to the first UE device 102 over the original sidelink communication path. In some situations, the sidelink path-switch criteria response may be an acknowledgement confirming the sidelink path-switch criteria. In other situations, the sidelink path-switch criteria response indicates a request to change the criteria. The sidelink path-switch criteria response may include an adjusted threshold, for example. Accordingly, the first UE device and the second UE device may negotiate to settle on a final agreed sidelink path-switch criteria. Additional sidelink path-switch criteria responses and messages may be exchanged between the devices 102, 104. In still other situations, the sidelink path-switch criteria response may be omitted.

At event 708, the second UE device 104 determines that a path-switch is required. For the MAB scenario, the determination that a path-switch is required is typically based on determination that the original sidelink communication path is no longer supporting communication between the UE devices 102, 104. The second UE device 104, for example, may detect an SL RLF. For the example, the first UE device 102 also determines that a path-switch is required at event 710.

After determining that a path-switch is required, each UE device 102, 104 retains the UE context of the other UE device. At event 712, therefore, the second UE device retains the first UE device context. At event 714, the first UE device 102 retains the second UE device context. The UE context includes at least the Packet Data Convergence Protocol (PDCP) configuration and Service Data Adaptation Protocol (SDAP) configuration for the sidelink communication link and the UE capability of the peer UE device. Each UE device 102, 104 also maintains the E2E PC5 RRC connection at event 716 even though the original sidelink communication path no longer supports communication. For the example, each UE device 102, 104 also starts a timer after determining a path-switch is required. If an alternate sidelink communication path is not identified before expiration of the timer, each UE device discards the E2E PC5 RRC connection and begins a procedure to reestablish the connection.

At transmission 718, a discovery signal is transmitted by an alternate relay UE device 132 and received by the second UE device 104. At transmission 720, a discovery signal is transmitted by another candidate relay UE device 508 and received by the second UE device 104. Other discovery signals may be transmitted by other candidate relay UE devices and received by the second UE device 104. At transmission 722, a discovery signal is transmitted by the first UE device 102 and received by the second UE device 104. The transmissions 718, 720, 722 may be Model A discovery signals or Model B discovery signals. In situations, where the discovery signals are Model B discovery signals, discovery signals requests are received at the transmitting device to invoke the transmission of the discovery signal. In the interest clarity and brevity, the discovery request transmissions are not shown in FIG. 7.

The second UE device 104 evaluates the received discovery signals 718, 720, 722 and selects a relay UE device for providing the alternate sidelink communication path. For the example, the second device selects the alternate relay UE device 132. The second UE device 104 evaluates at least the SD RSRP of the discovery signals to identify an alternate sidelink communication path. In some situations, other information may be available to the second UE device to select a path. Examples of such information include, neighbor devices of the devices transmitting discovery signals and link quality information to those neighbor devices. Accordingly, the selected relay UE device may be a UE device that facilitates a multiple relay UE device communication path. In some situations, the selected alternate sidelink communication path is a direct sidelink connection to the first UE device 102. For the example of FIG. 7, the sidelink path-switch criteria indicates that the second UE device is the designated UE device for selecting the alternate communication path. In other examples, the first UE device may be the designated selection device and the first device selects the alternate relay UE device 132.

At event 726, the alternate sidelink communication path 110 is established. In some situations, establishment of the alternate sidelink communication path 110 includes the second UE device 104 transmitting a direct communication request (DCR) message to the alternate relay UE device 132 where the DCR message includes a re-establishment indicator indicating a sidelink connection between the first UE device and the second UE device is being established. In response, the alternate relay UE device 132 device sends a DCR message with a re-establishment indicator to the first UE device which responds with a DCR response. In response to the DCR response, the alternate relay UE device 132 sends a DCR response to the second UE device to establish the alternate sidelink communication path.

In another example, the establishment of the alternate sidelink communication path 110 includes the second UE device 104 transmitting a PC5 RRC reestablishment message to the first UE device after PC5 connections are established between the UE devices 102, 104 and the relay UE device 132. Such a technique includes the second UE device 104 transmitting a DCR message to the alternate relay UE device where the DCR message is generated and transmitted in accordance to conventional DCR messages. The DCR message includes a first UE device identifier identifying the first UE device 102 a second UE device identifier identifying the second UE device 104. The alternate relay UE device 132 then transmits a DCR message to the first UE device that indicates the second UE device 104 is making a direct communication request to the first UE device 102. The first UE device 102 sends a DCR response message to the alternate relay UE device 132 and the alternate relay UE device 132 sends a DCR response message to the second UE device 104. After the PC5 connections are established, the second UE device sends the PC5 RRC reestablishment message to the first UE device indicating the communication session is a continuation of the communication session previously conducted over the original sidelink communication path. The PC5-RRC reestablishment message, therefore, indicates to the first UE device that the previous communication session is being reestablished. Although the PC5-RRC reestablishment message may include any of several formats and/or configurations, an example of a suitable PC5-RRC reestablishment message includes an SL Reconfiguration message with a reestablishment indicator. In one example, the reestablishment indicator in the SL Reconfiguration message is an information element (IE) for indicating that the SL Reconfiguration is a reestablishment of the previous communication link between the two UE devices 102, 104. The first UE device sends a PC5-RRC response message to the second UE device 104 to confirm the reestablishment of the communication link. An example of suitable PC5-RRC response message includes an RRCReconfigurationCompleteSidelink message.

At event 728, the second UE device 104 applies the first UE device context to the communication link between the first UE device and the second UE device. At event 730, the first UE device 102 applies the second UE device context to the communication link between the first UE device and the second UE device. After the contexts are applied, data communication between the first UE device and the second UE device 106 continues at event 732 over the alternate sidelink communication path facilitated by the alternate relay UE device 132.

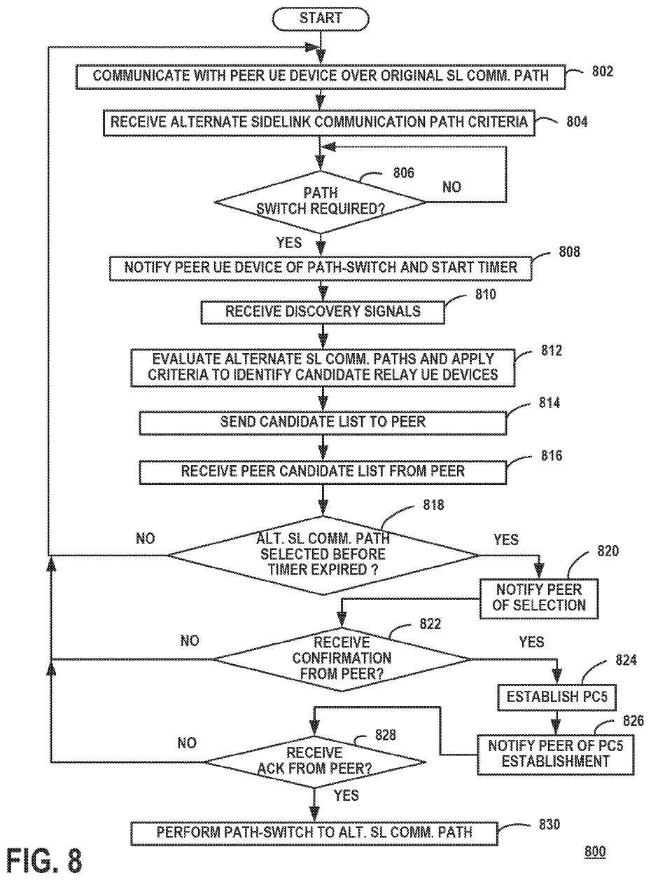

FIG. 8 is a flow chart of an example of a method 800 of performing an MBB path-switch procedure. For the example, the method 800 is performed at a UE device communicating over a sidelink connection with a peer UE device. Accordingly, the method 800 may be performed by the second UE device 104 in the 100 described above where the first UE device 102 is a peer UE device of the second UE device 104.

At step 802, the UE device communicates over an original sidelink communication path with a peer device. The original sidelink communication path may include a relayed communication path with one or more relay UE devices or may include a direct sidelink PC5 connection with the peer UE device.

At step 804, sidelink path-switch criteria are received from the peer UE device. For the example, the criteria are received in an RRC Reconfiguration Sidelink message forming the sidelink path-switch criteria message 108. In some situations, the UE device may respond to the sidelink path-switch criteria message received from the peer where the response may be an acknowledgment or at least a partial rejection of the criteria. For example, the UE device may send a message with indicating a requested adjustment to a parameter in the received criteria. In some situations, the UE device may send its own sidelink path-switch criteria message where one or more of the parameters are different from the parameters received from the peer UE device. The peer UE device may response to the adjusted parameters with an acknowledgment or with other adjustments. Accordingly, the UE device and the peer UE device may negotiate the sidelink path-switch criteria over several messages in some situations. For the example, the messages are transmitted over the original sidelink communication path

At step 806, the UE device determines if a path switch is required. The determination may be based on the sidelink path-switch criteria, preconfigured parameters, parameters received from a base station, or a combination thereof. For the example, the UE device determines a path-switch required when a measured SL RSRP is below a threshold. Where the original sidelink communication path is a direct sidelink connection to the peer UE device, the measured SL RSRP is a measured level of a signal received from the peer UE device over the direct PC5 connection. Where the original sidelink communication path is a relayed sidelink connection, the measured SL RSRP is a measured level of a signal received from a relay UE device. The SL RSRP threshold may be a preconfigured value, received from a base station, or part of the sidelink path-switch criteria. If no path-switch is required, the UE device continues to monitor conditions at step 806. If the UE device determines a path-switch is required, the method proceeds to step 808.

AT step 808, UE device notifies the peer UE device that a path-switch is required and starts a timer. For the example, the UE device transmits a message to the peer UE device over the original sidelink communication path. An example of suitable message for notifying the peer UE device includes a RRCReconfigurationSidelink message.

At step 810, discovery signals are received. The UE device receives discovery signals from nearby UE devices where the discovery signals may be Model A or Model B discovery signals. Accordingly, the UE device may transmit Model B discovery requests (queries) in some situations. The discovery signals may include signals transmitted from candidate relay UE devices and signals transmitted by the peer UE device.

At step 812, the candidate alternate sidelink communication paths are evaluated. The sidelink path-switch criteria are applied to identify candidate relay UE devices.

At step 814, the peer UE device is notified of the identified candidate relay UE devices. For the example, the UE device transmits a message with a candidate UE device list that includes at least one candidate UE device.

At step 816, the UE device is notified of the candidate relay UE devices identified by the peer UE device. For the example, the peer UE device transmits a message with a candidate UE device list that includes at least one candidate UE device.

At step 818, it is determined whether an alternate sidelink communication path has been identified before the timer has expired. The UE device evaluates the candidate UE device lists and selects an alternate relay UE device or determines that a direct sidelink connection should be used. For the example, the timer value for the timer is received as part of the sidelink path-switch criteria. If an alternate sidelink communication path cannot be identified before expiration of the timer the method returns to step 802 where communication continues over the original sidelink communication path. For the example, the UE device determines the timer has expired in the event an SL RLF is detected even if time remains on the timer. If a SL RLF is declared, the E2E PC5-RRC is released by both UE devices and a new E2E PC5-RRC connection must be established for communication to continue between the UE devices for the example. Accordingly, with a SL-RLF condition, the method does not return to step 802 to continue communication over the original sidelink communication path. New alternate communication path criteria may also be received at step 804. If the alternate sidelink communication path is identified, the method proceeds to step 820 where the peer UE device is notified of the selection and the timer is stopped. Accordingly, where the alternate sidelink communication path is relayed communication path, the UE device identifies the relay UE device(s) that will facilitate the path.

At step 822, it is determined whether the peer UE device has confirmed the selection of the alternate sidelink communication path. For the example, the peer UE device sends a message to the UE device after being notified of the selection where the message indicates whether the peer UE device confirms the selection. If the selection is not confirmed, the method returns to step 802. Otherwise, the method proceeds to step 824 where the UE device establishes a PC5 connection with the selected relay UE device.

At step 826, the peer UE device is notified of the establishment of the PC5 connection. The UE device sends message over the original sidelink communication path to the peer UE device indicating that the UE device has established a PC5 connection with the selected relay UE device.

At step 828, it is determined whether the peer UE device has acknowledged that the PC5 connection has been established and that the peer UE device has established a PC5 connection to the selected relay UE device of the alternate sidelink communication path. For the example, the peer sends an ACK message over the original sidelink communication path in response to the PC5 establishment notification message. If no acknowledgment is received, the method returns to step 802. Otherwise, a path switch from the original sidelink communication path to the alternate sidelink communication message is performed at step 830. Accordingly, the ACK message forms a trigger for the path switch. The UE device and the peer UE device apply the E2E PC5 RRC configuration and the UE context of the other UE device to the alternate sidelink communication path. Data communication with the peer UE device continues over the alternate sidelink communication path.

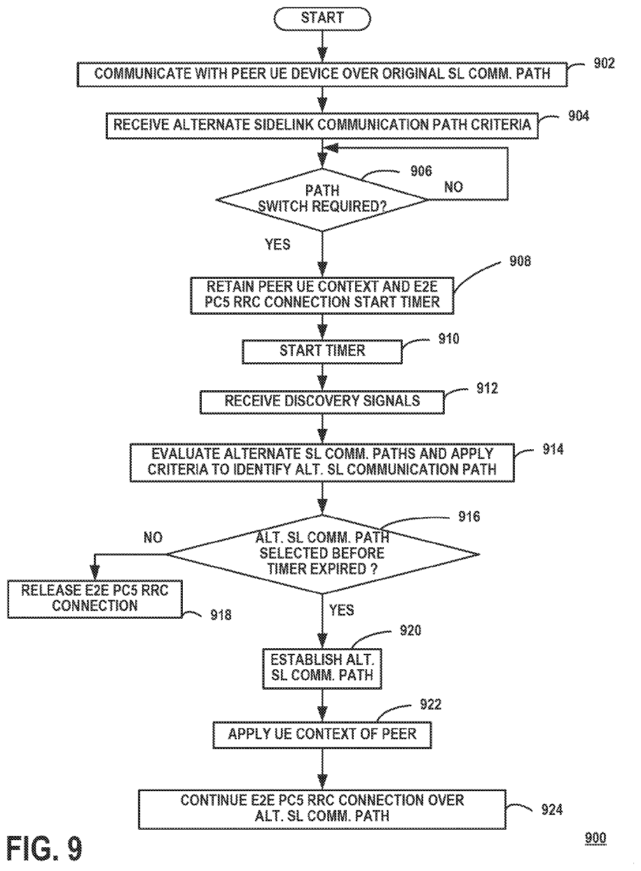

FIG. 9 is a flow chart of an example of a method 900 of performing an MAB path-switch procedure. For the example, the method 900 is performed at a UE device communicating over a sidelink connection with a peer UE device. Accordingly, the method 900 may be performed by the second UE device 104 in the system 100 described above where the first UE device 102 is a peer UE device of the second UE device 104.

At step 902, the UE device communicates over an original sidelink communication path with a peer device. The original sidelink communication path may include a relayed communication path with one or more relay UE devices or may include a direct sidelink PC5 connection with the peer UE device.

At step 904, sidelink path-switch criteria are received from the peer UE device. For the example, the criteria are received is in an RRC Reconfiguration Sidelink message forming the sidelink path-switch criteria message. In some situations, the UE device may respond to the sidelink path-switch criteria message received from the peer where the response may be an acknowledgment or at least a partial rejection of the criteria. For example, the UE device may send a message with indicating a requested adjustment to a parameter in the received criteria. In some situations, the UE device may send its own sidelink path-switch criteria message where one or more of the parameters are different from the parameters received from the peer UE device. The peer UE device may response to the adjusted parameters with an acknowledgment or with other adjustments. Accordingly, the UE device and the peer UE device may negotiate the sidelink path-switch criteria over several messages in some situations. For the example, the messages are transmitted over the original sidelink communication path

At step, 906, the UE device determines if a path switch is required. For the example, UE device determines a path switch is required when the original sidelink communication path is determined to no longer support communication between the UE device and the peer UE device. The UE device may determine that the original sidelink communication path no longer supports communication when a SL RLF detected, for example. If no path-switch is required, the UE device continues to monitor conditions at step 906. If the UE device determines a path-switch is required, the method proceeds to step 908.

AT step 908, UE device retains the UE context of the peer UE device and the E2E PC5 RRC connection. At step 910, a timer is started. The timer value is received in the sidelink path-switch criteria for the example and is the maximum time the UE device should retain the UE context of the peer UE device and the E2E PC5 RRC connection. Accordingly, if the alternate sidelink communication path is not established before the timer expires, the UE device discards the UE context of the peer UE device and the E2E PC5 RRC connection.

At step 912, discovery signals are received. The UE device receives discovery signals from nearby UE devices where the discovery signals may be Model A or Model B discovery signals. Accordingly, the UE device may transmit Model B discovery requests (queries) in some situations. The discovery signals may include signals transmitted from candidate relay UE devices and signals transmitted by the peer UE device.

At step 914, the candidate alternate sidelink communication paths are evaluated. The sidelink path-switch criteria are applied to identify an alternate sidelink communication path which may include one or more relay UE devices. The UE device selects an alternate relay UE device or determines that a direct sidelink connection should be used.

At step 916, it is determined whether an alternate sidelink communication path has been identified before the timer has expired. If an alternate sidelink communication path cannot be identified before expiration of the timer the method proceeds to step 918 where a new E2E PC5 RRC connection is established in accordance with conventional techniques. If the timer has not expired, the method continues at step 920.

At step 920, alternate sidelink communication path. As discussed above, at the alternate sidelink communication path may be established in different ways. Although other techniques may be used, one example of suitable technique includes sending DCR messages with an indication that the request is to establish a connection to support a communication session previously supported by another sidelink communication path. Another example includes establishing a PC5 connections with conventional DCR messages and sending an RRC reestablishment message to the peer UE device indication that the communication session is the previous session.

At step 922, the E2E PC5 RRC configuration and the UE context of the peer UE device is applied to the alternate sidelink communication path. The UE device and the peer UE device apply the E2E PC5 RRC configuration and the UE context of the other UE device to the alternate sidelink communication path.

At step 924, data communication with the peer UE device continues over the alternate sidelink communication path. Data communication with the peer UE device continues over the alternate sidelink communication path using the previous E2E PC5 RRC connection.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A user equipment (UE) device comprising:
a transceiver configured to communicate with a peer UE device over an original sidelink communication path;
the transceiver comprising a receiver configured to receive, over the original sidelink communication path, a sidelink path-switch criteria message comprising sidelink path-switch criteria for establishing an alternative sidelink communication path between the UE device and the peer UE device, the sidelink path-switch criteria comprising path-switch trigger information indicating at least one trigger for initiating an alternate sidelink communication path establishment procedure; and
a controller configured to establish the alternate sidelink communication path in accordance with the criteria.

2. The UE device of claim 1, wherein the sidelink path-switch criteria comprise a parameter selected from the group consisting of:
a maximum relay number parameter indicative of a maximum number of relay UE devices forming the alternate sidelink communication path;
a minimum link quality parameter indicative of a minimum quality of at least one communication link in the alternate sidelink communication path;
a preferred relay UE device identifier identifying a preferred relay UE device for establishing the alternate sidelink communication path;
an end-to-end (E2E) PC5-RRC connection timer parameter indicative of a maximum time for maintaining an E2E PC5-RRC connection of the original sidelink communication path after the original sidelink communication path has stopped supporting communication between the first UE device and the second UE device and the alternative sidelink communication path has not been established;
a path-switch timer parameter indicative of a maximum time for maintaining searching for the alternate sidelink communication path; and
combinations thereof.

3. The UE device of claim 1, wherein the controller is configured to establish the alternate sidelink communication path while the original sidelink communication path supports communication between the UE device and the peer UE device.

4. The UE device of claim 3, wherein the controller is further configured to initiate an alternate sidelink communication path establishment procedure to establish the alternate sidelink communication path, the controller configured to initiate the alternate sidelink communication path establishment procedure in response to at least one of the UE device or the peer UE device determining that a signal quality of at least one communication link in the original sidelink communication path has fallen below a minimum link quality threshold.

5. The UE device of claim 4, wherein the controller is configured to initiate the alternate sidelink communication path establishment procedure further in response to identifying an alternate path communication sidelink meeting the minimum link quality threshold.

6. The UE device of claim 5, wherein the receiver is configured to receive a discovery signal and the controller is configured to identify the alternate path communication sidelink based at least partially on the discovery signal.

7. The UE device of claim 6, wherein the receiver is configured to receive the discovery signal from a relay UE device and the alternate sidelink communication path comprises the alternate path communication sidelink to the relay UE device.

8. The UE device of claim 7, wherein the transceiver is further configured to exchange at least one signal with the peer UE device that confirms selection of the relay UE device for providing at least a portion of the alternate sidelink communication path.

9. The UE device of claim 8, wherein:
the controller is further configured to establish a PC5 connection with the relay UE device;
the transceiver comprises a transmitter configured to transmit, over the original sidelink communication path, a message indicating the PC5 connection has been established; and
the receiver is configured to receive, over the original sidelink communication path, an acknowledgment message from the second UE device.

10. The UE device of claim 9, wherein:
the controller is further configured to switch communication from the original sidelink communication path to the alternative sidelink communication path in response to the acknowledgment message.

11. The UE device of claim 6, wherein the received discovery signal is received from the peer UE device and the alternate sidelink communication path is a direct PC5 connection between the UE device and the peer UE device.

12. The UE device of claim 1, wherein the controller is configured to establish the alternate sidelink communication path after the original sidelink communication path is disconnected and no longer supports communication between the UE device and the peer UE device.

13. The UE device of claim 12, wherein the controller is configured to establish the alternate sidelink communication path after the original sidelink communication path experiences a sidelink radio link failure (SL RLF).

14. The UE device of claim 12, wherein the controller is further configured to initiate an alternate sidelink communication path establishment procedure to establish the alternate sidelink communication path, the controller configured to initiate the alternate sidelink communication path establishment procedure in response to determining that the original sidelink communication path is disconnected.

16. The UE device of claim 14, wherein the receiver is configured to receive a discovery signal and the controller is configured to identify an alternate path communication sidelink based at least partially on the discovery signal.

17. The UE device of claim 16, wherein the receiver is configured to receive the discovery signal from a relay UE device and the alternate sidelink communication path comprises the alternate path communication sidelink to the relay UE device.

18. The UE device of claim 17, wherein the controller is configured to reestablish an end-to-end (E2E) PC5-RRC connection used over the original sidelink communication path, the controller configured to reestablish the E2E PC5-RRC connection over the alternate sidelink communication path in response to determining the peer UE device is connected to the relay UE device.

19. The UE device of claim 12, wherein the controller is configured to, in response to expiration of a timer, release an end-to-end (E2E) PC5-RRC connection between the first UE device and the second UE device.
